(19) United States
(12) Patent Application Publication
(10) Pub. No.: US 2005/0069611 A1
(43) Pub. Date: Mar. 31, 2005

(54) Method and apparatus for manufacturing frozen or refrigerated half-boiled noodles

(76) Inventors: Isao Osako, Tokyo (JP); Takatoshi Zushi, Saitama-shi (JP); Michinari Ueki, Redondo Beach, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/670,603

(22) Filed: Sep. 26, 2003

(51) Int. Cl. A23C 3/00

(52) U.S. Cl. 426/323

(57) ABSTRACT

The present invention provides a method and an apparatus for easily manufacturing frozen or refrigerated half-boiled noodles of stable quality with constant moisture permeability and a fixed moisture content at low cost, which includes the steps of: boiling a measured quantity of noodles into a half-boiled state in which the moisture content is within the range of 45 to 60 percent as a whole; immediately holding the half-boiled noodles in a hermetically sealed condition to bring the sealed space into a substantially saturated steamy condition; slow-cooling the sealed noodles as they are to permeate moisture into the core of the noodles; and packing the cooled noodles to preserve them in freezing or refrigerative storage.

### TECHNICAL FIELD OF THE INVENTION

The present invention relates to a method for manufacturing frozen or refrigerated half-boiled noodles by which dried noodles or uncooked noodles (hereinafter, referred to as noodles) including spaghetti, macaroni, udon noodles, Japanese buckwheat noodles, and Chinese noodles are given flavorful eating quality with good texture in a short time and, more particularly, concerns a method and an apparatus for manufacturing noodles useful for spaghetti which takes a long time for boiling.

### DESCRIPTION OF THE RELATED ART

In general, noodle products including spaghetti, macaroni, udon noodles, Japanese buckwheat noodles, and Chinese noodles have the property of being unable to be suitable for handling and sanitary supervision unless they are packed in the unit of one to several meals in production and distribution mainly for restaurants. The noodle products are generally cooked in the unit of one to several meals from the state of dried noodles or the like immediately before they are eaten; thus, it takes a long time for cooking. Accordingly, quick-boil noodles are used in which only the surface of beta noodles such as dried or uncooked noodles is preprocessed into alpha by short-time boiling and then moisture from the exterior is absorbed into the inside beta part through the alpha layer to allow the noodles to be cooked by short-time heating at the time of eating (refer to Japanese Unexamined Patent Application Publication No. 6-261703).

However, since the related-art quick-boil noodles are soaked in water after boiling, it is difficult to keep a constant moisture content in the noodles, thus giving unstable good eating quality. When one or several meals of noodles on a tray or the like are frozen into a fixed shape, it involves the remove of the noodles from the tray and, since they are frozen in the shape of the tray, they cannot always be packed densely when packed into a package such as a corrugated cardboard carton, thus causing useless space.

On the other hand, Japanese Unexamined Patent Application Publication No. 10-84897 proposes a frozen-noodle manufacturing method in which half-boiled noodles are left in air without washing to be slowly cooled and then frozen. According to this frozen-noodle manufacturing method, since half-boiled noodles are slowly cooled by leaving it in air, it disadvantageously requires measures to prevent the propagation of bacteria and cannot give stable-quality (texture) frozen noodles with a constant moisture content because the moisture in the outer layer of the noodles permeates into the core and evaporates, thus having inconstant moisture permeability.

### SUMMARY OF THE INVENTION

The present invention has been made to solve the above problems caused by inappropriate post-processing of the half-boiled noodles. Accordingly, it is an object of the invention to provide a method and an apparatus for manufacturing frozen or refrigerated half-boiled noodles in which half-boiled noodles of stable quality (eating texture) with constant moisture permeability and a fixed moisture content can be easily manufactured at low cost.

It is another object of the invention to provide a method and an apparatus for manufacturing frozen or refrigerated half-boiled noodles in which half-boiled noodles can maintain eating texture, appearance, freshness etc. same as those cooked of dried noodles immediately before eating and can be cooked in a short time even if they are preserved in freezing storage for a long time or in refrigerative storage for a few days, thus being effective particularly for spaghetti and so on that require long cooking time.

It is another object of the invention to provide a method and an apparatus for manufacturing frozen or refrigerated half-boiled noodles in which the moisture content of the half-boiled noodles is maintained in a fixed low rate, thus causing no breakage of noodle texture due to expansion in volume during freezing, which allows rapid-freezing, slow-freezing, or refrigerative storage and also cooking by both of rapid-unfreezing and slow-unfreezing, thus facilitating handling without deteriorating the quality of the noodles and allowing refreezing of unfreezed noodles.

It is another object of the invention to provide a method and an apparatus for manufacturing frozen or refrigerated half-boiled noodles in which a large quantity of water is not used, as in the related-art examples, operation is easy, cost is reduced, and the storage space for noodles is reduced, so that storage and transportation cost can be reduced.

It is another object of the invention to provide a wrapped-noodle manufacturing apparatus suitable for mass-manufacturing the frozen or refrigerated half-boiled noodles.

In order to achieve the above objects, the method for manufacturing frozen or refrigerated half-boiled noodles according to the invention includes the steps of: boiling a measured quantity of noodles into a half-boiled state in which the moisture content is within the range of 45 to 60 percent as a whole; holding the half-boiled noodles in a hermetically sealed condition to bring the sealed space into a substantially saturated steamy condition; slow-cooling the sealed noodles to permeate moisture into the core of the noodles; and preserving the cooled noodles in freezing or refrigerative storage.

According to a preferred embodiment of the invention, the half-boiled noodles are packed in a sealed container in a hermetically sealed condition. The sealed pack is preferably a synthetic-resin bag. Preferably, the half-boiled noodles are brought into a hermetically sealed condition when the temperature of greater part of the noodles except the outside is at least 80° C.

Preferably, the slow-cooling speed of the noodles is 1 to 5° C./min and the slow-cooling time is 15 to 90 minutes. Preferably, the noodles held and slow-cooled in a hermetically sealed condition are put in a packaging container for freezing or refrigerative storage at the point within 90 minutes after the start of slow-cooling. The cooling speed means an average cooling speed until noodles are slow-cooled to a target temperature in the slow-cooling process.

In order to achieve the above objects, the apparatus for manufacturing frozen or refrigerated half-boiled noodles includes a weighing unit for weighing beta noodles including dried noodles or uncooked noodles in a unit quantity of package; a boiler for boiling the beta noodles into a half-boiled state in which the moisture content is within the range of 45 to 60 percent to preprocess the surface thereof into alpha; a wrapping unit for hermetically sealing the noodles boiled by the boiler into a sealed container of which the interior is in a substantially saturated steamy condition; a slow-cooling unit for slow-cooling the noodles wrapped by the wrapping unit at a cooling speed of 1 to 5° C./min until the moisture permeates into the core of the noodles; and a storage unit for preserving the slow-cooled noodles in freezing or refrigerative storage.

According to the method and the apparatus for manufacturing frozen or refrigerated half-boiled noodles, a unit package quantity of noodles that have been half-boiled with a moisture content of 45 to 60 percent is put into a synthetic-resin food bag or the like or wrapped with a synthetic-resin film and is held in a hermetically sealed state. Accordingly, hot noodles immediately after the boiling can be held in a sterilized condition and hermetically sealed under an appropriate moisture condition. Therefore, evaporation of moisture from the noodles can be prevented so that constant and appropriate moisture can be permeated into the core of the noodle, so that frozen noodles with a constant moisture content and stable quality can be easily manufactured at low cost.

Since the sealed noodles with appropriate moisture are under an appropriate moisture condition, moisture is appropriately absorbed from the outside alpha layer of the noodles into the inside beta part during the slow-cooling. Since the noodles are sealed in an appropriate moisture condition on a unit quantity basis, phenomena does not occur in which a partial excessive moisture accumulation appears or partial excessive moisture absorption swells the surface of the noodles in white. Moreover, since the moisture content is held constant, half-boiled noodles can maintain eating texture, appearance, freshness etc. same as those cooked of dried noodles even if they are preserved in freezing storage for a long time or in refrigerative storage for a few days, and moreover, they can be cooked in a short time.

Since the moisture content of the noodles is maintained in a fixed low rate, thus causing no breakage of noodle texture due to expansion in volume during freezing, which allows rapid-freezing, slow-freezing, or refrigerative storage and also allows cooking by both of rapid-unfreezing and slow-unfreezing, thus facilitating handling without deteriorating the quality of the noodles and allowing refreezing storage of unfreezed noodles.

Moreover, since a large quantity of water is not used to cool or wash the half-boiled noodles, unlike the related-art examples. Since a unit quantity of soft noodles just after boiling is hermetically sealed, it is easy to handle and cost can be reduced as compared with the case where they are put in a food bag after being frozen in advance.

According to the invention, since the cooled noodles are put in a packaging container such as a corrugated cardboard carton while maintaining a sealed condition and are then preserved in freezing or refrigerative storage, storage space for noodles can be reduced by about 30 percent relative to the related-art examples in which quick-boiled noodles are frozen and thereafter packed in a packaging container, so that cost for storage and transportation can be reduced.

### BRIEF DESCRIPTION OF DRAWINGS

FIG. 1 is a flow chart to describe the invented whole production system;

FIG. 2 is a schematic explanatory diagram of the whole structure of an automated noodle manufacturing apparatus implementing the present invention; and

FIG. 3 is a schematic explanatory diagram of the whole structure of a manual noodle manufacturing apparatus implementing the present invention.

### DESCRIPTION OF THE EMBODIMENTS

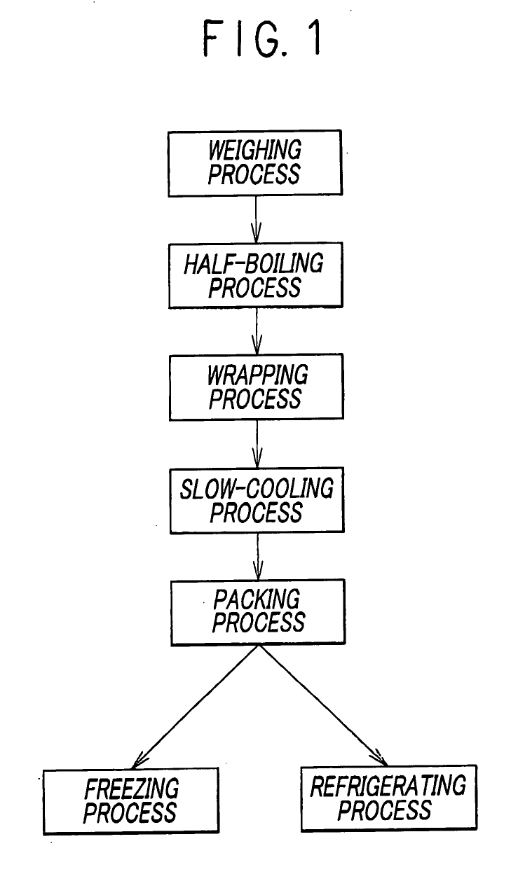

FIG. 1 is a flow chart to describe the invented whole production system.

In a weighing process, a unit quantity of dried noodles (for example, one to several meals) is weighed sequentially; in a half-boiling process, the dried noodles weighed in the weighing process are successively boiled into a half boiled state on a unit quantity basis; in a wrapping process, the unit quantity of half-boiled noodles is hermetically sealed into a synthesis-resin (polyethylene) food bag or wrapped with a synthesis-resin (polyethylene) film. The seal wrapping does not necessarily require a packet such as a bag and is not particularly limited only if it can hold a sealed condition to maintain the interior space in a substantially saturated steamy condition.

In the next slow-cooling process, the noodles hermetically sealed in the wrapping process are cooled to an appropriate temperature; in the next packing process, the cooled wrapped noodles are packed in a package such as a corrugated cardboard carton; and a freezing or a refrigerating process, the wrapped noodles packed in the corrugated cardboard carton in the packing process are frozen or refrigerated in the packed condition.

More specifically, in the weighing process, beta noodles such as dried or uncooked noodles including spaghetti, macaroni, udon noodles, Japanese buckwheat noodles, and Chinese noodles are automatically weighed in the unit of one to several meals by an automated weighing unit. The unit quantity of the noodles can be adjusted as appropriate as the unit quantity of noodles packed in the later-described packing process.

In the half-boiling process, the noodles weighed in the weighing process are put in, for example, a bucket on a conveyer, are conveyed to a boiler, and boiled in hot water into a half-boiled condition for a specified boiling time while being transferred in the tank of the boiler. The moisture content of the half-boiled noodles is preferably set within the range of 45 to 60 percent, and more preferably, within the range of 50 to 55 percent. When the moisture content is less than the lower limit, the noodle string tends to be broken, so that not only work efficiency but also heat conduction will be reduced to increase boiling time in cooking the produced wrapped noodles. On the other hand, when the moisture content exceeds the upper limit, the texture of noodles tends to be broken during the freezing to decrease the quality (eating texture).

The noodle boiling time in the boiler is necessary to boil the beta noodle into a half-boiled state to preprocess the surface into alpha; the time varies depending on the type of noodles; in general, it is about one third to one half of a time necessary for the eating quality of noodles. The boiling time for the dried noodles can be adjusted as appropriate by adjusting the length of the boiler tank or the carrying speed of the conveyer in the boiler.

In the next wrapping process, the noodles that have been half-boiled in the boiler are hermetically sealed into a synthesis-resin (polyethylene) food bag or wrapped with a synthesis-resin (polyethylene) film. According to the invention, as described above, there is no need to use a packet such as a bag as long as it can hold the interior space in a substantially saturated steamy condition. The half-boiled noodles are preferably hermetically sealed in a short time after the completion of the half-boiling process so that the temperature does not greatly decrease and a large quantity of moisture on the noodle surface does not evaporate.

More specifically, the case of putting the half-boiled noodles into a food bag will be described as an example. The noodles that have been half-boiled in the boiler are dropped from a bucket on the conveyer on a unit quantity basis through a shooter of the wrapping unit and are then put into a food bag made of synthetic resin such as polyethylene held below the shooter in the wrapping unit, and are immediately hermetically sealed.

The half-boiled noodles are hermetically sealed in a hot condition immediately after the boiling into the synthetic-resin food bag. Therefore, the noodles are put into the food bag in a sterilized condition and hot water (boiled water) and steam adhered to the noodles also enter the food bag together to keep the noodles in a substantially saturated steamy condition, thus being hermetically sealed with an appropriate moisture condition. In order to keep a constant moisture content of the noodles and to ensure the sterilized condition, the temperature of the greater part of the noodles except the outside is preferably at least 80° C. at the time of putting the half-boiled noodles into the food bag. At that time, the half-boiled noodles may be drained or added with hot water or steam as necessary. However, it is preferable to half-boil the noodles into a state in which such operations are not necessary.

The half-boiled noodles are beta noodles of which only the surface is preprocessed into alpha by short-time boiling. Dried noodles have a hard property; on the other hand, half-boiled noodles immediately after boiling are soft, thus being easily sealed.

Among the related-art quick-boiled noodles, those that are cooled by cooling water after boiling increase in volume owing to the moisture entering the noodles during the process, whereas according to the invention, the half-boiled noodles are hermetically sealed without the cooling by cooling water, so that the moisture does not increase, thus not increasing the volume of the noodles.

In the next slow-cooling process, the wrapped noodles are cooled to nearly a room temperature of about 30 to 20° C. spontaneously or with cooling clean air or the like.

Since the sealed noodles with appropriate moisture are under an appropriate moisture condition, the moisture is appropriately absorbed from the outside alpha layer into the inside beta part during the slow-cooling. Therefore, the moisture content of the whole noodles becomes substantially constant and uniform, which is effective to reduce cooking time thereafter and to improve the eating quality. The saturated steam in the sealed packet is relieved with a decrease in the temperature of the packet.

Since the noodles are sealed in an appropriate moisture condition on a packet unit basis, phenomena does not occur in which a partial excessive moisture accumulation appears or partial excessive moisture absorption swells the surface of the noodles into white.

In order to maintain the eating texture, appearance, freshness and so on of the noodles cooked from dried noodles, it is appropriate to cool the noodles at a cooling speed of 1 to 5° C./min for 15 to 90 minutes. For the slow-cooling speed, it is preferably set to 2 to 4° C./min, more preferably, 1.5 to 3° C./min. For the slow-cooling time, it is preferably set to 20 to 70 minutes. When the slow-cooling speed becomes less than 1° C./min, the cooling time tends to take longer and the productivity slows down. When the cooling speed exceeds 5° C./min and so the cooling time decreases to less than 15 minutes, the permeation of moisture into the center of noodles tends to become insufficient to increase cooking time and to deteriorate eating quality.

Since the steam that has entered the food bag together with noodles condenses into water in the food bag and is absorbed by the noodles while the noodles are cooled to about 30 to 20° C., the packet comes into a vacuum condition to decrease in volume.

In the packing process, the slow-cooled wrapped noodles are put into a packaging container such as a corrugated cardboard carton or a container by machine or hand as necessary.

In the next freezing or a refrigerating process, the wrapped noodles put in the packaging container are reserved in freezing or refrigerative storage in a state in which they are stored in the packaging container.

The freezing storage is suitable for storing wrapped noodles for a long period of time; wrapped noodles stored in a packaging container are gradually frozen to a temperature of −20° C. or less into frozen noodles and thereafter preserved in freezing storage in a state in which they are stored in the packaging container for a long period of time.

It is preferable to put the noodles that have been slow-cooled in the sealed package into the packaging container at the point in time within 90 minutes after the start of slow-cooling, that is, the point in time when the noodles have not become so hard.

The refrigeration is suitable for storing wrapped noodles for a few days; wrapped noodles in the packaging container can be preserved as cold/chilled noodles at a temperature of about 5° C. in a refrigerator for a few days.

As described above, by the method of manufacturing half-boiled noodles according to the present invention, a measured quantity of noodles half-boiled with a moisture content of 45 to 60 percent is put into a synthetic-resin food bag or the like or wrapped with a synthetic-resin film to be held in a hermetically sealed condition. Accordingly, the hot noodles immediately after the boiling can be wrapped in a sterilized condition and can be hermetically sealed with an appropriate moisture condition. Therefore, frozen noodles with a constant moisture content and stable quality can be manufactured easily at low cost.

The invention is not necessarily limited to the foregoing; although the cooling temperature of the wrapped noodles in the slow-cooling process is preferably about 30 to 20° C., it is not limited to that.

The freezing process of the present invention is preferably carried out after the slow-freezing. However, it is not necessarily limited to that and it can be done after one hour of rapid freezing in about 1 hour. This is because the moisture content of noodles is relatively as low as 45 to 60 percent, so that both freezing methods can be employed. A high moisture content is not suitable for slow-freezing.

Furthermore, according to the invention, half-boiled noodles may be coated with a release agent such as cooking oil or pH adjuster and then be wrapped.

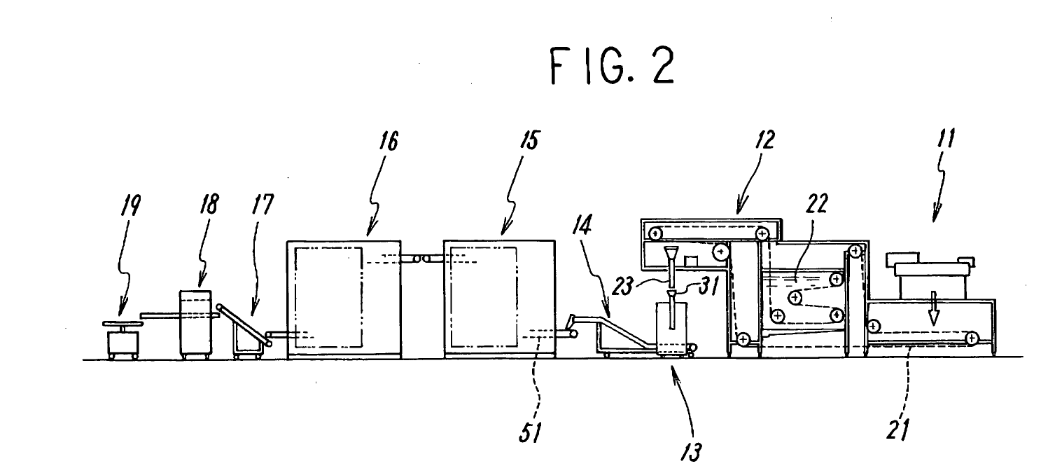

Referring next to FIG. 2, an embodiment of an apparatus for performing the above-described method will be described.

FIG. 2 shows the structure of an apparatus for manufacturing a half-boiled wrapped noodles (an automated production line) according to the present invention, which includes a weighing unit 11 for weighing and supplying a unit quantity of dried noodles or uncooked noodles, a boiler 12 for half-boiling the noodles, a wrapping unit 13 for wrapping the boiled noodles, a conveying unit 14 for conveying the wrapped noodles to the next stage, a slow-cooling unit 15 for slow-cooling the wrapped noodles, a freezer 16 for rapidly freezing the slow-cooled wrapped noodles, a transfer unit 17 for transferring the wrapped noodles let out from the freezer 16 to the next unit, an inspection unit 18 for performing a final inspection of the frozen wrapped noodles, and a cradle 19 for setting the inspected frozen wrapped noodles into a corrugated cardboard carton or the like.

The weighing unit 11 is composed of a known automated weighing machine. The weighing unit 11 automatically weighs one meal of beta noodles which are dried noodles such as udon noodles, Japanese buckwheat noodles, and spaghetti on a wrapping unit basis. The unit quantity of the beta noodles can be adjusted as appropriate. The beta noodles that have been weighed with the weighing unit 11 into a unit quantity are dropped into a bucket (not shown) of a conveyer 21 of the boiler 12 in the next stage which extends below the weighing unit 11 in synchronization with the movement of the conveyer 21. The bucket of the conveyer 21 is automatically covered with a lid after the noodles have been put therein and is then transferred. The weighing unit 11 can weigh and drop a measured quantity of noodles every plurality of lines. For uncooked noodles (cut noodles), a metering cutting machine serves as the weighing unit.

The boiler 12 for half-boiling the noodles puts the beta noodles that have been put in the bucket by the conveyer 21 into a boiler tank 22 for half-boiling in order to preprocess the surface thereof into alpha. The transferred beta noodles are boiled in hot water for a specified boiling time while being transferred in the boiler tank 22.

The time for boiling the noodles in the boiler 12 is the time required to boil them into a half-boiled condition in which the surface of the beta noodles is preprocessed into alpha and the moisture content of the noodles is within the range of 45 to 60 percent; generally, it is preferable one third to one half of normal noodle-boiling time, as described above. The time for boiling the noodles can be adjusted to a suitable time by adjusting the length of the boiler tank 22 of the boiler 12, or the carrying speed of the conveyer 21 in the boiler tank 22.

The noodles that have been boiled in the boiler 12 for a specified time are put into the wrapping unit 13 from the bucket on the conveyer 21 by unit quantity. More specifically, the noodles are dropped into a slot 31 of the wrapping unit 13 through a shooter 23 disposed below the conveyer 21 when the lid of the bucket is opened, and are put into a bag made of synthetic resin of polyethylene or the like held below the slot 31 in the wrapping unit 13, and are immediately sealed.

The shooter 23 and the slot 31 of the wrapping unit 13 are joined so as not to be open to the exterior as much as possible, so that the slot 31 communicates with the boiler tank 22, and moreover, the half-boiled noodles are immediately put into the synthetic-resin bag. Therefore hot water and steam adhered to the noodles also enter the bag to bring the interior of the bag into a substantially saturated steamy condition.

The noodles wrapped by the wrapping unit 13 are transferred to the next slow-cooling unit 15 by the conveying unit 14. The conveying unit 14 may include a part for horizontally carrying the wrapped noodles and also a space for an operator in the vicinity thereof. This allows the operator to perform an in-process visual inspection for removing improperly wrapped ones or to correct the shape of the noodles wrapped in the synthetic-resin bag so as to be fit in the corrugated cardboard carton in the next packing process.

The wrapped noodles are transferred to the slow-cooling unit 15 by the conveying unit 14. The slow-cooling unit 15 cools the noodles to substantially room temperature at a cooling speed of 1 to 5° C./min with cooling clean air or the like and permeates moisture into the core of the noodles during the slow-cooling. The slow-cooling time is set to 15 to 90 minutes, as described above; however, it is adjusted depending on the speed of a conveyer 51 for conveying the wrapped noodles in the slow-cooling unit 15.

The wrapped noodles slow-cooled by the slow-cooling unit 15 are transferred to the freezer 16 for quickly freezing them. The freezer 16 is one for quickly freezing the half-boiled noodles for preservation.

The wrapped noodles frozen by the freezer 16 are transferred to the inspection unit 18 in the next stage by the transfer unit 17. The transfer unit 17 includes an aligning function for arranging the wrapped noodles to be transferred to the inspection unit 18 in line as necessary.

The inspection unit 18 for performing a final inspection of the frozen wrapped noodles includes a metal sensor for inspecting whether or not metals exist in the sealed package of the frozen wrapped noodles and a weight checker for checking whether or not the weight of the frozen wrapped noodles is proper.

The cradle 19 for placing the checked frozen wrapped noodles is one for temporarily placing the frozen wrapped noodles for packing them into a packaging container such as a corrugated cardboard carton. The frozen wrapped noodles are automatically or manually put in the packaging container from the cradle 19 on after another. The packed frozen wrapped noodles are preserved in a freezing storage unit as appropriate.

In the above-described apparatus, the noodles slow-cooled by the slow-cooling unit 15 are frozen by the freezer 16, while the freezer 16 may be replaced with a refrigerator. In this case, the packed noodles are preserved in freezing or refrigerative storage unit.

The wrapped noodles slow-cooled by the slow-cooling unit 15 may be directly transferred to the inspection unit 18 by the transfer unit 17 without being rapidly frozen by the freezer 16, that is, without the freezer 16. In this case, after the wrapped noodles transferred to the cradle 19 through the inspection unit 18 have been packed, they are frozen or refrigerated in storage.

According to the half-boiled noodles manufacturing apparatus, the weight, the processing temperature, the processing time, and the number can be easily and automatically measured in each process stages of the weighing unit 11, the boiler 12, and other processing units. Therefore, reliable management of raw materials allows the production line by the manufacturing apparatus to easily comply with Hazard Analysis Critical Control Points (HACCP) system, thereby providing high-quality half-boiled noodles.

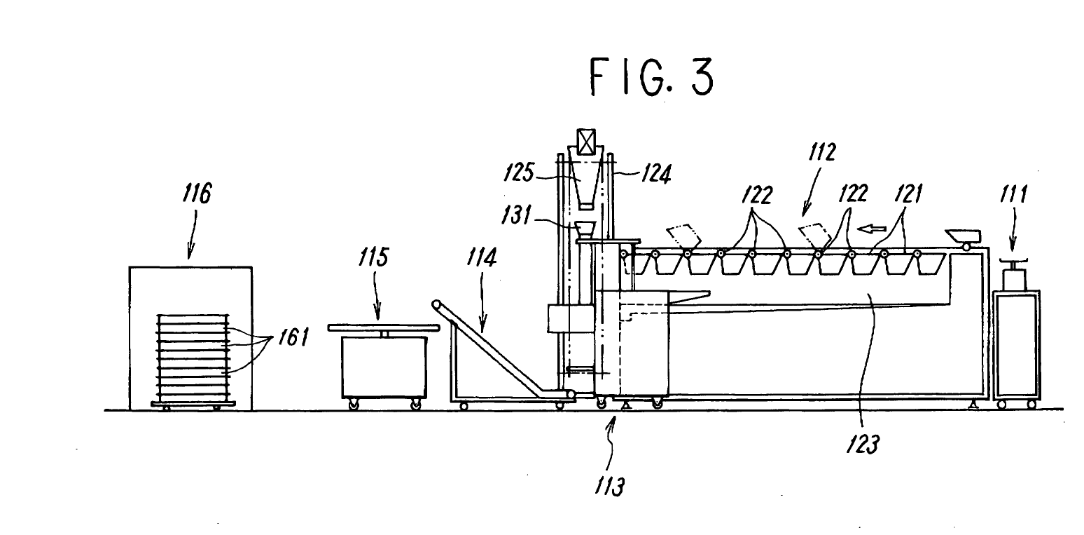

FIG. 3 shows the structure of a half-boiled noodle manufacturing apparatus of the present invention which is applied to a manual production line.

The apparatus includes a weighing unit 111 for weighing and supplying a unit quantity of dried noodles or uncooked noodles, a boiler 112 for half-boiling the noodles, a wrapping unit 113 for wrapping the half-boiled noodles, a conveying unit 114 for conveying the wrapped noodles to the next stage, a cradle 115 for setting the wrapped noodles into a tray or the like, and a slow-cooling unit 116 for slow-cooling the wrapped noodles in the tray or the like.

The weighing unit 111 is composed of a known automated weighing machine. The weighing unit 111 weighs one to several meals of beta noodles which are dried noodles or uncooked noodles (cut noodles) such as udon noodles, Japanese buckwheat noodles, and spaghetti manually by the operator. The weighed beta noodles are put into rolling buckets 121 of the boiler 112 in the next stage at regular time intervals. The unit quantity of beta noodles weighed by the weighing unit 111 can be put into a plurality of partitioned regions of the buckets 121.

The boiler 112 for half-boiling the noodles is constructed such that the large number of buckets 121 with many holes are arranged in the direction of carrying the noodles in a boiler tank 123 and can be rotated by shafts 122 that support them, as indicated by phantom lines in the drawing. The bucket 121 is sequentially turned over, so that the beta noodles put in the bucket 121 on the right of the drawing are put into the next bucket 121 on the left, thereby being conveyed in the direction of the arrow while being boiled in hot water, and are then carried from the left end of the boiler tank 123 to a transfer unit 124 after the time required for half-boiling, which was described with reference to FIG. 2. The time to boil the noodles is appropriately set by adjusting the length of the boiler tank 123 of the boiler 112 or the turning-over time of the buckets 121 in the boiler tank 123 in a stepless manner.

The noodles that have been half-boiled by the boiler 112 are lifted to the upper part of the wrapping unit 113 by the transfer unit 124, from which they are put into a slot 131 of the wrapping unit 113 through a shooter 125 by unit quantity. They are then put into a bag made of synthetic resin of polyethylene or the like held under the slot 131 of the wrapping unit 113 and are immediately sealed automatically. In this case, it is necessary to bring the interior of the bag into a substantially saturated steamy condition, similarly to that of FIG. 2.

The noodles wrapped by the wrapping unit 113 are transferred to a cradle 115 by the conveying unit 114. The cradle 115 is one for temporarily placing the wrapped noodles for visually inspecting the wrapped noodles, improving the shape, and putting them into trays 161 or the like. The wrapped noodles put in the trays 161 are stacked on a carriage every specific quantity and fed to the slow-cooling unit 116. The slow-cooling speed of the slow-cooling unit 116 is as described above. The wrapped noodles that have been slow-cooled may be preserved here in refrigerative storage or may be transferred to a separate freezer for quick freezing.

### EXAMPLES

Dried spaghetti with a weight of 100 g and a diameter of 1.9 mm were heated in hot water for 5 minutes to make half-boiled noodles with an alpha surface and a moisture content of 51%. They were taken out from the hot water, then immediately put into a polyethylene food bag, hermetically sealed (the interior of the bag immediately after the sealing was in a substantially saturated steamy condition), and cooled at room temperature (25° C.) and at a cooing speed of about 1.8° C./min for about 30 minutes. The cooled noodles had a temperature of about 43° C. and the bag had little vapor because the steam therein was absorbed by the noodles, thus having flexibility to be packed at a high density in a corrugated cardboard carton. The corrugated cardboard carton containing a large number of wrapped noodles was put in a freezer of −30° C. and preserved in freezing storage for 20 days. The frozen wrapped noodles had a weight of 180 g and a moisture content of about 51.7%.

The frozen wrapped noodles that were boiled for about 90 seconds and dried spaghetti that was boiled for 12 minutes which is a standard boiling time for preprocessing into alpha were prepared. Both of them with previously heated sauce were compared. There was no difference in the appearance, freshness, taste, firmness, and firm texture between them.

Specifically, the spaghetti frozen by the method of the present invention could be cooked in about one eighth of the standard boiling time required to preprocess the dried spaghetti into alpha. Moreover, there was no difference in eating quality, appearance, freshness and so on relative to those that were cooked directly of dried spaghetti. Accordingly, it has been confirmed that this is an outstanding method for preserving half-boiled dried noodles in freezing or refrigerative storage in eating quality and texture.

Similarly, spaghetti that was stored at 5 to 10° C. for three days after cooling was boiled and tasted. This exhibited no difference in eating quality and texture from those of dried spaghetti of the same type and quantity that was boiled for a specified time.

Furthermore, as a mistreatment test for the frozen wrapped noodles according to the above method, spaghetti that was left for natural unfreezing for 24 hours, frozen again, and naturally unfreezed again was tasted. This exhibited no degradation in eating quality and texture.

Frozen perfect-alpha noodles require instantaneous unfreezing; thus, they have normally poor eating quality when subjected to natural unfreezing or refreezing.

1. A method for manufacturing frozen or refrigerated half-boiled noodles, comprising the steps of:
boiling a measured quantity of noodles into a half-boiled state in which the moisture content is within the range of 45 to 60 percent as a whole;
holding the half-boiled noodles in a hermetically sealed condition to bring the sealed space into a substantially saturated steamy condition;
slow-cooling the sealed noodles to permeate moisture into the core of the noodles; and
preserving the cooled noodles in freezing or refrigerative storage.

2. A method for manufacturing frozen or refrigerated half-boiled noodles according to claim 1, wherein
the half-boiled noodles are packed in a sealed container in a hermetically sealed condition.

3. A method for manufacturing frozen or refrigerated half-boiled noodles according to claim 2, wherein
the sealed container includes a synthetic-resin bag.

4. A method for manufacturing frozen or refrigerated half-boiled noodles according to one of claims 1 to 3, wherein
the half-boiled noodles are brought into a hermetically sealed condition when the temperature of greater part of the noodles except the outside is at least 80° C.

5. A method for manufacturing frozen or refrigerated half-boiled noodles according to one of claims 1 to 4, wherein
the slow-cooling speed of the noodles is 1 to 5° C./min and the slow-cooling time is 15 to 90 minutes.

6. A method for manufacturing frozen or refrigerated half-boiled noodles according to one of claims 1 to 5, wherein
the noodles held and slow-cooled in a hermetically sealed condition are put in a packaging container for freezing or refrigerative storage at the point within 90 minutes after the start of slow-cooling.

7. An apparatus for manufacturing frozen or refrigerated half-boiled noodles, comprising:
a weighing unit for weighing beta noodles including dried noodles or uncooked noodles in a unit quantity of package;
a boiler for boiling the beta noodles into a half-boiled state in which the moisture content is within the range of 45 to 60 percent to preprocess the surface thereof into alpha;
a wrapping unit for hermetically sealing the noodles boiled by the boiler into a sealed container of which the interior is in a substantially saturated steamy condition;
a slow-cooling unit for slow-cooling the noodles wrapped by the wrapping unit at a cooling speed of 1 to 5° C./min until the moisture permeates into the core of the noodles; and
a storage unit for preserving the slow-cooled noodles in frozen or refrigerated storage.
